(19) United States
(12) Patent Application Publication
(10) Pub. No.: US 2023/0210202 A1
(43) Pub. Date: Jul. 6, 2023

(54) RESPIRATORY MASK AND METHOD OF PRODUCTION

(71) Applicant: Sanko Tekstil Isletmeleri San. Ve Tic. A.S., Inegol - BURSA (TR)

(72) Inventors: Fatih KONUKOGLU, Inegol - BURSA (TR); Kenan LOYAN, Inegol - BURSA (TR); Esref TUNCER, Inegol - BURSA (TR); Ahmet ÖZKAN, Inegol - BURSA (TR); Mahmut ÖZDEMIR, Inegol - BURSA (TR); Baris ÖZDEN, Inegol - BURSA (TR); Esin Kalfa KILIÇKAN, Inegol - BURSA (TR); Adnan KOCAMER, Inegol - BURSA (TR); Tuncay IYIDOGAN, Inegol - BURSA (TR); Fatih DÖNMEZ, Inegol - BURSA (TR)

(21) Appl. No.: 17/928,081

(22) PCT Filed: May 31, 2021
(86) PCT No.: PCT/EP2021/064537

§ 371 Date: Nov. 28, 2022

(30) Foreign Application Priority Data
May 31, 2020 (EP) 20177635.8

(51) Int. Cl. A41D 13/11; D03D 1/00; D03D 15/47; D03D 13/00; A41D 31/102

(52) U.S. Cl. CPC A41D 13/1192; D03D 1/0035; D03D 15/47; D03D 13/004; D03D 13/008; A41D 31/102; D02G 3/328

(57) ABSTRACT

A respiratory mask including a mask fabric body (1), and one or more holding straps (3) for holding the mask body to the face of a user, the mask body being made of a woven fabric having weft yarns and warp yarns, the weft and warp yarns having a count comprised between 10 and 1100 den, the warp density being between 14-130 warps/cm, the weft density being between 12-70 wefts/cm, wherein at least part of the body is provided with a liquid-repellent crosslinked polymer.

### FIELD OF THE INVENTION

The present invention relates to respiratory masks and to a method of their production. More specifically, the present invention relates to a protection mask to be worn on the face. The invention also relates to a method for the production of this mask.

### STATE OF THE ART

Personal respiratory masks, also known as “face masks” or “filtering face masks”, are protective devices used to protect the wearer's respiratory system from airborne particles. Facial masks are in fact worn over the nose and mouth of the user to protect him from unwanted material suspended in the air. In some embodiments (namely those without a valve that let breath exit the mask) the mask also acts as a filter to prevent or reduce the leakage of any particles suspended in the user's breath to protect other people from possible infections of the person wearing mask. Known masks are typically made of non-woven fabric in two forms: a cup-shaped shape or a flat shape in which the non-woven fabric is partially folded on itself to be able to adapt to the shape of the face when worn. One type of flat mask is known as a “surgical mask”. Flat masks made of woven fabric are also known.

A mask requires the presence of straps or bands, preferably of elastic material, which generally are in the form of loops that pass around the user's ears or around the user's head to keep the mask in the desired position on the user's face. The straps or equivalent retaining means are typically made separately and are attached to the body of the mask, by means such as sewing, gluing, ultrasonic welding, stapling or other means commonly known to those skilled in the art. Protective devices are also known in which the retaining means are loops of elastic material attached to a folded portion of the mask body.

The production of flat masks of the so-called surgical type discussed above is normally carried out with automatic machines that carry out in line all or almost all the necessary operations, such as cutting and folding the portion of non-woven fabric, welding or otherwise constraining the elastic straps that hold the body of the mask on the user's face and attaching the metal strip to the top side of the mask.

A face mask also typically requires the presence of a strip of plastically bendable material, generally a metal strip, that is located at the upper edge of the mask, i.e. at the side of the mask that is transversally floating over the bridge of the nose of the user when the mask is worn. This so-called “nose clip” may actually be made of any material provided it can be easily bended in a shape fitting to the bridge of the nose of the user to improve the air tightness of the mask.

One problem with known non-woven masks is that they can normally only be used only once and that they are difficult to be sanitized. This problem results in an increase in costs each time the mask is replaced, and in an increase in the mass of special waste to be treated.

Woven fabric masks are known. Woven fabric masks are more expensive than the non-woven fabric masks but woven masks may be washed or otherwise sanitized to be used several times. However, a woven mask complying with the relevant safety standards, such as one or more of the requirements provided in EN 14683, normally loses its standard-complying properties after washing. A problem of woven masks is therefore that their “surgical grade” is lost after washing.

### SUMMARY OF THE INVENTION

An aim of the present invention is to solve the above discussed problems. More specifically, an object of the present invention is to provide a face protection mask which is made of woven fabric and that is at the same time inexpensive to manufacture and that can be washable several times, still assuring compliance with the relevant safety standards. Another aim of the invention is to provide an inexpensive method of production of a protection mask in woven fabric.

These and other aims are reached by the present invention that relates to a respiratory mask and to a relevant production method according to the enclosed independent claims. Preferred aspects are recited in the dependent claims.

According to an aspect, a respiratory mask includes a mask fabric body and holding straps for holding the mask body to the face of a user. The mask body is made of a woven fabric having weft yarns and warp yarns, the weft and warp yarns having a count comprised between 10 and 1100 den (i.e. between NE 4.8 and 531), the warp density being between 14-130 warps/cm, the weft density being between 12-70 wefts/cm. At least part of the fabric of mask body is provided with a liquid-repellent crosslinked polymer.

A liquid-repellent crosslinked polymer is repellent at least to one liquid. For the present case the liquid-repellent crosslinked polymer is repellent at least to water. More preferably the liquid-repellent composition is repellent to at least water, oils and ionic liquids. Even more preferably the liquid-repellent crosslinked polymer is repellent to substantially all liquids.

The liquid-repellent crosslinked polymer is preferably located at least on both the outside face and the inside face of the mask. In other words, the body of the mask has a first, outer, face and a second, inner, face. The first, outer, face of the body is the external, visible side of the mask, when the mask is worn by a user. The second, inner, face of the body is the side of the mask which faces the skin (e.g., the mouth and the nose) of the user when the mask is worn by the user. Preferably, the body of the mask is provided with the liquid-repellent crosslinked polymer on both the first face and the second face, as well as throughout its thickness, i.e. for at least part of its thickness, preferably throughout the whole thickness of the fabric between the two faces of the body, namely throughout the whole thickness between the first face and the second face of the body of the mask.

A mask made from a fabric body having the above features and provided with a liquid-repellent crosslinked polymer is easy to produce, and provides that requirements of recognized standards are met, even after the mask is washed several times; e.g. the mask is complying with the said standard (the mask is “surgical grade”) up to 15 washings. Such washings may be carried at a temperature between 40° and 90°, preferably between 60° C.-90° C. Exemplary of some recognized requirements are e.g. present in EN 14683.

According to a preferred aspect, the count of the warp and of the weft yarns is comprised between 20 and 600 den, more preferably between 50 and 400 den, even more preferably between 80 and 250 den. The warp density is preferably comprised between 50 and 100 warps/cm, while the weft density is preferably comprised between 20 and 40 wefts/cm.

Warp and weft can be elastic or inelastic, comprising staple fibres (preferably obtained from natural fibers) or man-made (typically polymeric) fibers. Regarding yarns comprising staple fibers, these yarns can be 100% staple fibers. They can also comprise other fibers, e.g. the yarns may be corespun yarns, preferably a yarn comprising an core and a sheath, e.g. a sheath of staple fibers. The core may consist of elastomeric fibers, or of non-elastomeric fibers, or a mixture of both, i.e. the core comprises both elastomeric fibers and non-elastomeric fibers. Elastomeric fibers are typically continuous fibers, i.e. filaments.

Elastomeric yarns that can be used as core are known in the art, and are defined e.g. in ASTM D3107. Exemplary elastomeric cores comprise one or more elastan filaments.

In both cases (i.e. 100% staple fiber or staple fibers+other component), the total count of the yarn is preferably between NE 5 and NE 80, more preferably between NE 20 and 60. If an elastomeric core is used, the count of the elastomeric core is preferably between 5 and 900 den, more preferably between 10 and 300 den.

According to a different possible embodiment, the warp and/or weft yarns comprise yarns consisting of man-made fibers, typically filaments (i.e. continuous fibers) having a count comprised between 10 and 1000 den, preferably between 20 and 600 den.

The yarns made from man-made fibers can comprise elastomeric fibers, typically one or more elastomeric filaments or yarns, e.g. elastan. Various man-made non elastomeric fibers can be used, such as PP, PBT, T400, Dyeneema fiber, and also polyester or polyamide fibers. The total count of elastomeric filaments being between 5 and 900 den, preferably between 10 and 300 den, more preferably between 20 and 200 den.

Elastomeric and non-elastomeric fibers (typically both filaments—i.e. continuous fibers) can be coupled in known ways, e.g. intermingling twisting, etc., to provide a composite yarn that can be used as warp and/or weft in the present invention. In possible embodiments, however, yarns from man-made fibers can also be 100% non-elastomeric.

The body is preferably made from a woven fabric having a weight comprised between 60 and 500 g/m², preferably between 110 and 300 g/m². The mentioned weight values refer to the weight of the fabric provided with the liquid-repellent crosslinked polymer, i.e. to the weight of the fabric after that the fabric is provided with an aqueous composition including at least a crosslinkable polymer and a crosslinking agent, dried and, preferably, cured. In embodiments, the woven fabric of the body has preferably air permeability according to ASTM D0737 between 30 and 800 mm/s, preferably between 50 and 300 mm/s, even more preferably 90 and 200 mm/s. The mentioned air permeability values refer to the weight of the fabric provided with the liquid-repellent crosslinked polymer, i.e., to the weight of the after that the fabric is provided with the above mentioned aqueous composition, dried and, preferably, cured.

According to possible embodiments, an elastic fabric can be used for the body. Preferred elastic fabrics have stretchability (i.e. elongation), in warp and/or weft direction (preferably in weft direction) comprised between 10 and 60%, more preferably 30% to 50%, even more preferably 35 to 45%. Elongation is measured according to ASTM D3107, after 3 home washes (as defined in ISO 6330:2012 6N, wherein 6N discloses the washing program). According to the present description, measurements according to ASTM

D3107 are carried out using a weight of 3 lb, and the weight is applied to the fabric for 30 min.

Stretchability provides comfort to the mask, i.e. it allows the mask adapt to the face of different users, i.e. to different dimension faces. In alternative possible embodiments the fabric of the body can be inelastic or substantially inelastic, (i.e. substantially non-stretchable, having stretch according to ASTM D3107 equal or close to 0%). Exemplary inelastic fabrics may be free of elastomeric fibers.

To provide comfort, the woven fabric can be provided with pleats. A possible embodiment provided with pleats uses corespun yarns, having a core of man-made fibers and a sheath of staple fibers (typically natural fibers). In particular, during thermal treating of the fabric (e.g. during washing, curing, sanforizing, etc.), the core may plastically deform, to provide pleats to the final fabric. Pleats can be used for both elastic and inelastic fabric.

The end fabric (after sanforizing) has dimensional stability of washing in warp and weft direction between −12% to 0%, more preferably between −8% to 0%, even more preferably between −5% to 0%. Dimensional stability of washing is measured according to ISO 3759:2011, after 3 home washes (as e.g. defined in ISO 6330:2012 6N, wherein 6N discloses the washing program). According to a possible aspect, a strip of plastically bendable, malleable, material may be applied to the body. Holding straps, preferably elastic, are attached to the body. They can be produced together with the woven fabric of the body (i.e. being part of the same woven fabric as the body as disclosed in co-pending application EP 20170451.7), or may be produced separately and subsequently joined (e.g. glued, sewn, etc.) to the body.

In a preferred embodiment the fabric includes weft yarns having different elasticity in different regions of the mask body, so as to enable the face mask to adapt and fit to the wearer's face. The weft yarns are woven according to a fabric construction to improve fitting performance of the woven fabric. Exemplary suitable fabric weaves can be any one of Sateen, Plain, Twill, Double Face, Panama, Ribs, Mixed Dobby Weave.

Preferred embodiments have a body with the following features:
Warp Yarns: staple fibers yarns with count between NE 20 and NE 40
Weft Yarns: elastomeric core+staple fibers sheath, total count between NE 20 and NE 40
Fabric Weight (after 3 home washes): between 110 and 300 g/m²
Warp density: between 50 and 100 warps/cm
Weft density: between 20 and 40 wefts/cm

The invention woven face mask is manufactured by known weaving machines, preferably jacquard and dobby machines. An object of the present invention is a mask production method wherein the body of a mask fabric is woven from warp and weft yarns, holding straps are provided to the body, the body is at least partially provided with a liquid-repellent crosslinked polymer.

A fabric as obtained on the loom may include a plurality of bodies that are adjacent to each other in the fabric; they are thus produced together in an amount that depends on the width of the loom in the weaving machine and on the dimensions of the mask. After the required finishing steps the fabric is cut into individual bodies for different masks. According to the production and the cutting, the bodies may already be provided with the holding straps, or holding straps may obtained from a different process (or from different parts of the fabric from which the bodies were obtained) and subsequently joined to the relevant bodies.

As above mentioned, at least part of the body of the mask of the invention is provided with a liquid-repellent crosslinked polymer.

According to embodiments, the liquid-repellent crosslinked polymer on the mask comprises at least one or more liquid-repelling agents (i.e., liquid-repelling polymer), one or more crosslinking agents and, optionally, one or more wetting agents. In other words, the crosslinked polymer on the mask may be in the form of a film including, in addition to a liquid-repellent agent (i.e., the liquid-repellent polymer) and a crosslinking agent suitable to crosslink such liquid-repellent agent, also additional components, such as, for example, a wetting agent.

According to embodiments, the liquid-repelling agent is in an amount (in a dry, finished fabric) between 0.5-10 g/m² of fabric, preferably between 1-9 g/m² of fabric, more preferably between 3-7 g/m² of fabric.

As used herein, the term “liquid-repelling agent”, refers to an agent (i.e., a polymer) which is suitable to impart at least liquid-repelling features to a substrate, e.g., a fabric. Preferably, the liquid-repelling agent, i.e., the liquid-repelling polymer, is a fluoropolymer, more preferably a C4-C6 fluoropolymer. According to embodiments, the liquid-repelling agent is selected from C6 based fluorocarbons, fluoro-silicone hybrids, C4 based fluoropolymers, fluoro-free wax, paraffin based products, fatty acids derivatives, modified wax, nano scale surface structure dendrimers, hyperbranched polymers and/or dendrimers, dendrimers with hydrophobic end groups, silicon based emulsions, silicon emulsion and catalyst, reactive silicone based systems and mixture thereof. Preferably the agent is selected from C6 based fluorocarbons, fluoro silicon hybrids, C4 based fluoropolymers and mixtures thereof.

According to embodiments, in the final, dry, fabric, the crosslinking agent is in an amount between 0.1-5 g/m² of fabric, preferably between 0.5-3 g/m² of fabric, more preferably between 1-2 g/m² of fabric.

The crosslinking agent contributes to the attachment, in particular, of the liquid-repelling agent to the fabric, i.e., to the body of the mask. In particular, the crosslinking agent allows for the crosslinking between the liquid-repelling polymer molecules and for the crosslinking of the liquid-repellent polymer molecules with the fabric. This allows mask of the invention to be washed several times, even at temperatures up to 90° C. without having its features jeopardized. According to embodiments, the crosslinking agent is selected from acrylic polymers and copolymers, resins, polyurethanes, blocked isocyanates, poly-isocyanates, polycarboimides, polycarbodiimides and mixtures thereof.

According to embodiments, the amount of wetting agent per square meter of the dry fabric is in a range between 0.001-0.2 g/m² of fabric, preferably between 0.005-0.1 g/m² of fabric, more preferably between 0.01-0.05 g/m² of fabric.

According to embodiments, the wetting agent is selected from ethoxylate, sulphonate and phosphonate nonionic wetting agents.

Optionally, the crosslinked polymer on the fabric, e.g., the film of crosslinked polymer on the fabric, may further comprise an antimicrobial agent. The antimicrobial agent may be in an amount between 0.002-0.3 g/m² fabric, preferably between 0.005-0.1 g/m² fabric, more preferably between 0.01-0.05 g/m² fabric.

According to embodiments, the antimicrobial agent is selected from metal ions and metal salts, quaternary ammonium compounds, poly biguanid compounds, triclosan, n-halamine compounds, chitosan, peroxyacids.

The present invention allows for the production of a respiratory mask which can be washed and that can withstand several home washes. In other words, the present invention allows for the production of a mask, including a crosslinked liquid-repelling agent, i.e. a crosslinked liquid-repelling polymer, which can be home washed several times, while maintaining substantially the same liquid repellency and user protection characteristics. In particular, a surgical grade mask results to maintain its characteristics substantially unaltered even after at least 15 home washings at a temperature up to 90° C., particularly in the range from 40° C. to 90° C., or 60° to 90°. This is particularly true when the body of the mask is made with a fabric which is provided on both its sides with the liquid-repellent crosslinked polymer. For example, an aqueous composition including a liquid-repelling polymer and a crosslinking agent may be provided to the fabric by padding. The fabric is then dried and preferably cured, so that a dry crosslinked polymer is provided to the fabric. When the aqueous composition is provided to the fabric by padding or impregnation, the aqueous composition penetrates in the fabric, so that, after drying and, preferably, curing, a fabric which is provided with the liquid-repellent crosslinked polymer on both its sides, as well as, inside at least part of the fabric (i.e., of the fabric's thickness), is obtained. Without being bound to a specific explanation, it is herein hypothesized that, when the fabric, i.e. the body of the mask, is provided with the aqueous liquid-repellent composition on both its sides, as well as, through at least part of its thickness, the liquid-repellent crosslinked polymer is provided not only to the surface of the two sides of the fabric, but also inside the fabric, so that the mask can be washed several times without substantially losing its characteristics, to be complying with the relevant requirements (exemplary requirements being present in EN 14683) even after several home washings.

Another object of the invention is a process for the production of a respiratory mask according to enclosed process independent claim, comprising the following steps:

a. providing a woven fabric having weft yarns and warp yarns, the weft and warp yarns having a count comprised between 10 and 1100 den (i.e. between NE 4.8 and 531), the warp density being between 14-130 warps/cm, the weft density being between 12-70 wefts/cm;
b. providing at least part of said woven fabric with an aqueous liquid-repellent composition drying, and, preferably, curing, to obtain a treated dry fabric;
c. sanforizing the treated fabric of point b.,
d. working said dry fabric into a mask.

According to embodiments, the aqueous liquid-repellent composition comprises at least one or more liquid-repelling agents (namely, liquid-repelling polymers), one or more crosslinking agents, optionally one or more wetting agents and, optionally, one or more antimicrobial agent. According to an aspect, the liquid-repellent composition is an aqueous composition, i.e., a composition that includes water and that is free or substantially free from added solvents.

According to embodiments, the liquid-repelling agent in aqueous the composition is in an amount between, 20-300 g/l, preferably 90-200 g/l, more preferably 110-150 g/l.

According to embodiments, the liquid-repelling agent is a polymer selected from C6 based fluorocarbons, fluoro-silicone hybrids, C4 based fluoropolymers and mixtures thereof. Other suitable liquid-repelling agents may be selected from fluoro-free wax, paraffin-based products, fatty acids derivatives, modified wax, nano scale surface structure dendrimers, hyperbranched polymers and/or dendrimers, dendrimers with hydrophobic end groups, silicon based emulsions, silicon emulsion and catalyst, reactive silicone based systems and mixtures thereof. Preferably, the liquid-repelling polymer is selected from C4-C6 fluorocarbons. For example, the commercial product “Nuva N EE6” (Archroma), a fluorocarbon, is an exemplary product suitable to be used in the present invention as a liquid-repellent agent. Commercial products “Phobol NB-NH” (Huntsman) and “Nuva N2155” (Archroma) are other exemplary products suitable to be used in the present invention as liquid-repellent agents.

According to embodiments, the crosslinking agent in the aqueous composition is in an amount between, 2-50 g/l, preferably 5-40 g/l, more preferably 10-30 g/l.

According to embodiments, the crosslinking agent is selected from the group consisting of acrylic polymers and copolymers, resins, polyurethanes, blocked isocyanates, poly-isocyanates, polycarboimides, polycarbodiimides and mixtures thereof. For example, the commercial product “Arkophob Dan” (Archroma), is a product suitable to be used in the present invention as a crosslinking agent.

According to embodiments, the wetting agent in the aqueous composition is in an amount between 0.2-5 g/l, preferably 0.5-4 g/l, more preferably 1-3 g/l.

According to embodiments, the wetting agent is selected from ethoxylate, sulphonate and phosphonate nonionic wetting agents, and mixtures thereof. For example, the commercial product “Fluowet UD”

(Archroma), is an exemplary product suitable to be used in the present invention as a wetting agent.

According to embodiments, the antimicrobial agent in the aqueous composition is in an amount between 1-30 g/l, preferably 5-20 g/l, more preferably 10-15 g/l.

According to embodiments, the antimicrobial agent is selected from metal ions and metal salts, quaternary ammonium compounds, poly biguanid compounds, triclosan, n-halamine compounds, chitosan, peroxyacids. For example, the commercial product “Sanitized T 11-15” (SpecialChem), is an exemplary product suitable to be used in the present invention as an antimicrobial agent. The commercial products “Silvadur 930 Flex” (Dow Chemical Company) and “Pulcraquat TX” (Pulcra Kimya Sanayi ve Ticaret A. [symbol] ) are other exemplary products suitable to be used in the present invention as antimicrobial agents.

According to embodiments, the aqueous composition, as well as the dry mixture including the crosslinked polymer on the final fabric may further comprise a perfume and/or an essential oil. Suitable perfumes and essential oils are, per se, known in the art.

According to embodiments, the aqueous composition may have a pH between 4-7, preferably between from about 4.5 to about 6.

The aqueous composition may be produced through known methods. For example, it may be produced by mixing the different components. According to embodiments, the components may be provided and admixed together to obtain the aqueous composition. According to embodiments, two or more components may be provided sequentially during the mixing. The pH can be adjusted, if necessary, using, for example, acetic acid.

According to embodiments, before being provided with the aqueous liquid-repellent composition, the fabric may be subjected to singeing on both sides of the fabric and to combined oxidative desizing and bleaching, then washed and dried. Such steps may be performed according to techniques that are, per se, known in the art.

The aqueous composition may be applied to the fabric according to techniques that are known per se in the art. For example, according to embodiments, the composition may be provided to the fabric by padding or spraying or by exhaust method. Preferably, the composition is applied to the fabric by padding.

Padding is a technique that is per se known in the art in the field of textiles. In general, a padding process comprises a step of impregnating the fabric with an aqueous composition; the impregnated fabric is passed between at least two rollers, so that the impregnated fabric is pressed by the two rollers, so that the impregnated fabric is squeezed and exceeding composition is removed. Subsequently, the fabric may be dried and cured.

According to embodiments, padding is carried out at a temperature between 20-35° C., preferably 23-28° C. In other words, the aqueous liquid-repellent composition is provided to the fabric at a temperature between 20-35° C., preferably 23-28° C.

According to embodiments, the fabric provided with the composition, is dried at a temperature ranging from 100° C. to 150° C., preferably from 120° C. to 140° C.

According to embodiments, the fabric is cured at a temperature ranging from 150° C. to 220° C., preferably from 170° C. to 200° C., for a time preferably ranging from 30 s to 180 s, preferably from 40 s to 140 s.

Drying and, optionally, curing, may be carried out according to techniques that are, per se, known in the art. For example, drying and curing may be carried out using a stenter frame.

Without being bound to a specific scientific explanation, it has been observed that the high temperatures of the drying and curing step, e.g., a curing step carried out between 170-200° C., allows the volatile chemicals come from the padding solution (i.e., from the liquid-repellent composition) in/on the fabric to be removed from the fabric. Thus, the main, non-volatile chemical compounds of the composition, remain on the fabric, in the form of a liquid-repellent crosslinked polymer. Such crosslinked polymer allows the mask to meet the requirements of recognized standards, such as one or more of the requirements discussed in EN 14683, even after 15 home washes at a temperature up to 90° C., e.g. the mask is complying with the above mentioned standard (the mask is “surgical grade”) up to 15 washings at a temperature up to 90° C. The fabric provided with the liquid-repellent crosslinked polymer can safely contact the skin of the user, e.g., when the mask is worn, even after several washes.

According to embodiments, the dried fabric undergoes a sanforizing step. The sanforizing step may be performed according to techniques that are, per se, known in the art.

Embodiments of the present invention also relate to a medical textile article, preferably a medical gown, being at least partially made of a woven fabric according to one or more of the aspects above discussed, and provided with a liquid-repellent crosslinked polymer according to one or more of the aspects above discussed.

Preferred embodiments of the medical article thus comprise a fabric having weft yarns and warp yarns, the weft and warp yarns having a count comprised between 10 and 1100 den, the warp density being between 14-130 warps/cm, the weft density being between 12-70 wefts/cm. At least part of the fabric is provided with a liquid-repellent crosslinked polymer.

As mentioned, the liquid-repellent crosslinked polymer is provided at least on a first face and on a second face (opposite to the first face) of the fabric of the article, preferably also through at least part of the thickness of the fabric.

Preferably, in the above mentioned woven fabric of the medical article, warp and/or weft yarns comprise yarns comprising staple fibers, having a count comprised between NE 5 and NE 80, preferably between NE 20 and NE 60.

In addition/alternative, yarns comprising staple fibers can be used, that comprise an elastomeric core and a sheath of staple fibers, the count of the elastomeric core being between 5 and 900 den, preferably between 10 and 300 den, more preferably 20 and 200 den.

The woven fabric for the medical article can comprise warp and/or weft yarns consisting of man-made fibers, having a count comprised between 10 and 1000 den, preferably between 20 and 600 den. In these yarns, the total count of elastomeric filaments is preferably between 5 and 900 den, preferably between 10 and 300 den, more preferably 20 and 200 den.

According to preferred embodiments, the fabric for the medical article is a woven fabric having a weight comprised between 60 and 500 g/m², preferably between 110 and 300 g/m², the weight being referred to the fabric provided with the liquid-repellent crosslinked polymer.

The fabric for the medical article preferably has air permeability according to ASTM D0737 between 30 and 800 mm/s, preferably between 50 and 300 mm/s, even more preferably 90 and 200 mm/s, the air permeability being referred to the fabric provided with the liquid-repellent crosslinked polymer.

According to a preferred aspect, the fabric maintains the above values even after 10 washings, more preferably even after 15 washes. In other words, the fabric, even after being washed 10 times, preferably even after 15 times, has air permeability according to ASTM D0737 falling in the above disclosed ranges. The mentioned washings may be carried at a temperature between 40° and 90°, preferably between 60° C.-90° C. Exemplary of some recognized requirements are e.g. present in EN 14683.

According to a preferred aspect, considering a first value v1 of air permeability, measured after the first washing, and a second value v2 of air permeability, measured after the 15th washing, the second value is less than 30% greater than the first value (i.e. v2≤1.3*v1), more preferably less than 20% greater than the second value (i.e. v2≤1.2*v1).

In possible embodiments, value v2 is comprised between 1.05 and 1.3 times the value v1, more preferably between 1.07 and 1.2 times the value of v1.

According to possible embodiments, the fabric of the medical article is made from a woven fabric having elongation, after 3 home washes, in warp and/or weft direction comprised between 10 and 60% according to ASTM D3107, preferably between 30 and 50%, even more preferably between 35% and 45%.

Preferably, the liquid-repellent crosslinked polymer used for the medical article comprises at least one or more liquid-repelling polymers, one or more crosslinking agents, and optionally one or more wetting agents.

In particular, the liquid-repelling polymer can be in an amount between 0.5-10 g/m² of fabric, preferably between 1-9 g/m² of fabric, more preferably between 3-7 g/m² of fabric.

In preferred embodiments of the medical article, the liquid-repelling polymer is a fluoropolymer, preferably selected from C6 based fluorocarbons, fluoro-silicone hybrids, C4 based fluoropolymers, and mixtures thereof. The crosslinking agent is preferably in an amount between 0.1-5 g/m² of fabric, preferably between 0.5-3 g/m² of fabric, more preferably between 1-2 g/m² of fabric, the crosslinking agent being selected from acrylic polymers and copolymers, resins, polyurethanes, blocked isocyanates, poly-isocyanates, polycarboimides, polycarbodiimides and mixtures thereof.

For the medical article, the wetting agent is preferably in an amount between 0.001-0.2 g/m² of fabric, preferably between 0.005-0.1 g/m² of fabric, more preferably between 0.01-0.05 g/m² of fabric, the wetting agent being selected from ethoxylate, sulphonate and phosphonate nonionic wetting agents.

Preferably, the crosslinked polymer used for the medical article further comprises an antimicrobial agent, preferably in an amount between 0.002-0.3 g/m² fabric, preferably between 0.005-0.1 g/m² fabric, more preferably between 0.01-0.05 g/m² fabric, the antimicrobial agent being selected from metal ions and metal salts, quaternary ammonium compounds, poly biguanid compounds, triclosan, n-halamine compounds, chitosan, peroxyacids.

### BRIEF DESCRIPTION OF THE DRAWINGS

The invention will now be disclosed with reference to the following schematic and exemplary, non-limiting drawings in which:

FIG. 1 is a schematic view of a mask according to the invention in use condition;

FIG. 2 is an enlarged and schematic view of the fabric making the body of the mask of FIG. 1.

FIG. 3 is an enlarged and schematic view of an alternative exemplary fabric making the body of the mask of FIG. 1.

FIG. 4 is a schematic view of the repeating unit of an alternative embodiment of a fabric according to the invention.

### DISCLOSURE OF PREFERRED EMBODIMENTS

With reference to the figures, the mask M includes a mask body 1 made of a woven fabric 10 including warp yarns 11 and weft yarns 12. The woven fabric 10 is preferably a single layer fabric.

The weft and warp yarns 11, 12 have a count comprised between 10 and 1100 den, preferably between 20 and 600 den, more preferably between 50 and 400 den, even more preferably between 80 and 250 den.

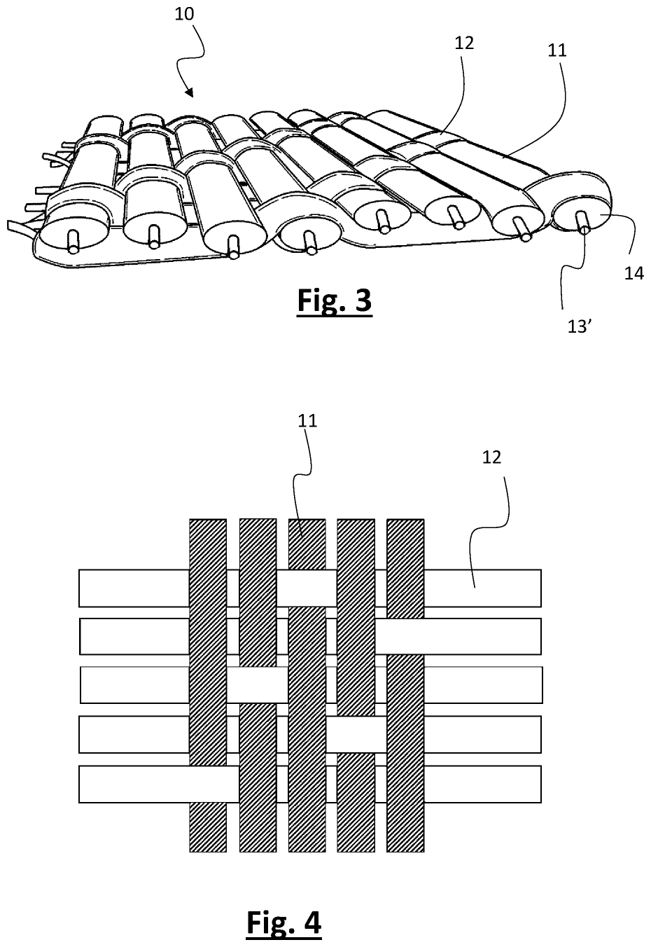

Warp yarns 11 and/or weft 12 can be elastic or inelastic. In other words, the warp and/or the weft can comprise elastomeric fibers 13 (typically filaments) and non-elastomeric fibers 14, or consist of non-elastomeric fibers 14. Non elastomeric fibers can be staple fibers, typically natural fibers. Man-made fibers, typically continuous filaments, can be also used in different. When the warp and/or the weft yarns comprise elastomeric fibers 13, 13′ (typically filaments), each yarn may include one or more elastomeric filament. For example, in the exemplary fabric of FIG. 2, each warp yarn include two elastomeric fibers 13 as core of the yarn. In the exemplary fabric of FIG. 3, each warp yarn includes one elastomeric fiber 13 as core of the yarn.

Weft and/or warp yarns 11, 12 comprising staple fibres have preferably a total count between NE 5 and NE 80, more preferably between NE 20 and NE 60. If corespun yarns are used, the total count of the core is preferably between 5 and 900 den, more preferably between 10 and 300 den, even more preferably 20 and 200 den. As mentioned, the core can comprise elastomeric and/or non-elastomeric fibers. In some embodiments, the core can be exclusively composed of elastomeric fibers, while alternative embodiments are provided with core consisting of non-elastomeric fibers.

As mentioned, according to a different possible embodiment, the warp and/or weft yarns 11, 12 comprise yarns consisting of man-made fibers, typically filaments (i.e. continuous fibers) having a count comprised between 10 and 1000 den, preferably between 20 and 600 den.

As mentioned, the yarns made from man-made fibers can be 100% non-elastomeric, or they can comprise elastomeric fibers 13. Preferred elastomeric fibers are elastomeric filaments or yarns, e.g. elastan. Various man-made non-elastomeric fibers can be used, e.g. such as polypropylene (PP), polybutylene terephthalate (PBT), elastomultiester (e.g. T400), Dyeneema fiber, or also generally polyester or polyamide fibers. If present, the total count of elastomeric fibers 13 is between 5 and 900 den, more preferably between 10 and 300 den, even more preferably between 20 and 200 den.

Elastomeric and non-elastomeric man-made fibers (typically both filaments—i.e. continuous fibers) can be coupled in known ways, e.g. intermingling twisting, etc., to provide a composite yarn that can be used as warp yarns 11 and/or as weft yarn 12 in the fabric 10.

Independently from the kinds of warp yarns 11 and weft yarns 12, the warp density is between 14-130 warps/cm and the weft density being between 12-70 wefts/cm. Preferred values for the warp density are comprised between 50 and 100 warps/cm. Preferred values for the weft density are comprised between 20 and 40 wefts/cm.

In embodiments, the fabric is provided with cotton inelastic warp yarns having a count of NE 30 to NE 60, and with elastic weft yarns (typically corespun, with elastomeric core and cotton sheath) having a count of NE 25 to NE 40. A typical fabric composition is 98.32% cotton and 1.68% elastan.

The woven fabric 10, provided with the liquid-repellent crosslinked polymer, has preferably a weight comprised between 60 and 500 g/m², preferably between 110 and 300 g/m².

Also, the woven fabric 10 of the body 1, provided with the liquid-repellent crosslinked polymer, has preferably air permeability according to ASTM D0737 between 30 and 800 mm/s, preferably between 50 and 300 mm/s, even more preferably between 90 and 200 mm/s.

The woven fabric 10 of the body 1 can be stretchable or substantially non-stretchable. When the fabric 10 is stretchable, stretchability (i.e. elongation) of the woven fabric of the body, in warp and/or weft direction (preferably in weft direction) is preferably comprised between 10 and 60%, more preferably 30 to 50%, even more preferably 35 to 45%. Elongation is measured according to ASTM D3107, after 3 home washes (as e.g. defined in ISO 6330). In particular, elongation is measured according to ASTM D3107, after 3 home washes (as e.g. defined in ISO 6330:2012 6N, wherein 6N discloses the washing program) using a weight of 3 lb, applied to the fabric for 30 min. As above discussed, dimensional stability after 3 home washes is comprised between −12% and 0%, more preferably between −8 and 0%, even more preferably between −5% and 0%, and is measured according to ISO 3759:2011.

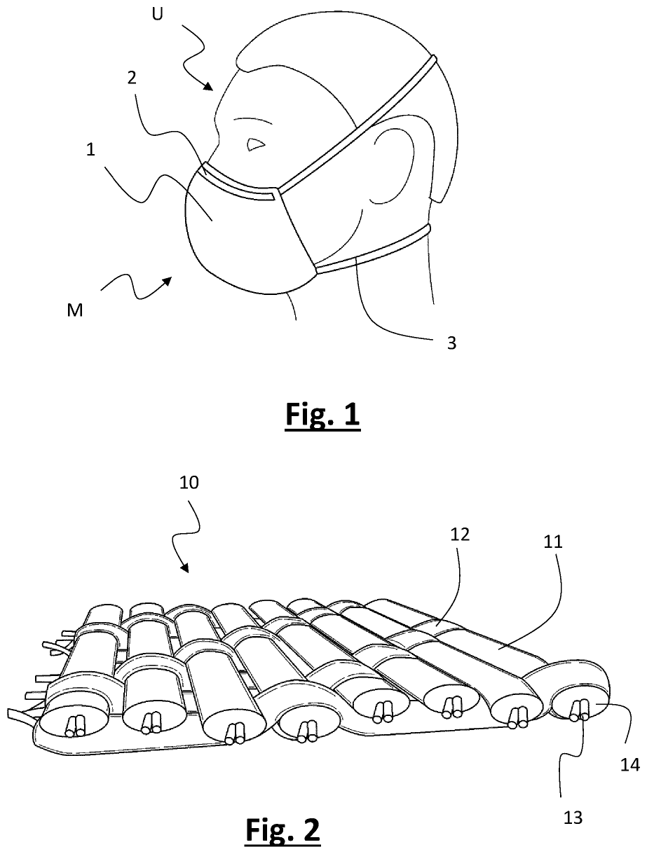

Preferred weaves for the fabric 10 are Sateen, Plain, Twill, Double Face, Panama, Ribs, Mixed Dobby Weave. In FIG. 1, a 3/1 twill fabric is shown. Preferred embodiments are twill (e.g. 3/1 twill) and sateen (e.g. 4/1 sateen fabric). In FIGS. 2 and 3, a 3/1 twill fabric is shown, while in FIG. 4 a 4/1 sateen fabric is shown. A more preferred embodiment is a 4/1 sateen fabric, wherein the warp and/or weft yarns are core-spun yarns, having a core comprising elastomeric filaments and a sheath covering the core, e.g. a sheath of inelastic staple fibers or inelastic filaments.

According to a possible aspect, there is provided a strip 2 of plastically bendable material forming a so-called “nose clip”. The mask M is also provided with one or more holding straps 3, made from the fabric 10 or from a different material. The one or more holding straps 3 is/are preferably elastic, to keep the mask M in the correct position on a user U.

At least part of the body 1 (i.e. at least part of the fabric 10) is provided with a liquid-repellent crosslinked polymer. Preferably, the body 1 is provided with the liquid-repellent crosslinked polymer at least on both the outer side and the inner side. Accordingly, the outer side of the body 1 is the external, visible side of the mask M, when the mask M is worn by a user U. The inner side of the body 1 is the side of the mask M which faces the skin (e.g., the mouth and the nose) of the user U when the mask M is worn by the user U.

According to an aspect, the liquid-repellent crosslinked polymer comprises at least one or more liquid-repelling agents, one or more crosslinking agents, and optionally one or more wetting agents.

The liquid-repelling agent, in the dry fabric, may be in an amount between 0.5-10 g/m² of fabric, preferably between 1-9 g/m² of fabric, more preferably between 3-7 g/m² of fabric.

Preferably, the liquid-repelling agent is selected from C6 based fluorocarbons, fluoro-silicone hybrids, C4 based fluoropolymers, fluoro-free wax, paraffin based products, fatty acids derivatives, modified wax, nano scale surface structure dendrimers, hyperbranched polymers and/or dendrimers, dendrimers with hydrophobic end groups, silicon based emulsions, silicon emulsion and catalyst, reactive silicone based systems and mixture thereof, and more preferably from C6 based fluorocarbons, fluoro silicon hybrids, C4 based fluoropolymers and mixtures thereof. Preferably, the liquid-repelling agent, i.e., the liquid-repelling polymer is a fluoropolymer. In embodiments, the liquid-repelling agent is selected from C6 fluoropolymers, C4 fluoropolymers and mixtures thereof.

Preferably, the crosslinking agent is in an amount between 0.1-5 g/m² of fabric, preferably between 0.5-3 g/m² of fabric, more preferably between 1-2 g/m² of fabric.

In particular, the crosslinking agent may be selected from acrylic polymers and copolymers, resins, polyurethanes, blocked isocyanates, poly-isocyanates, polycarboimides, polycarbodiimides and mixtures thereof.

In the dry fabric, the amount of wetting agent per square meter of the fabric is in a range between 0.001-0.2 g/m² of fabric, preferably between 0.005-0.1 g/m² of fabric, more preferably between 0.01-0.05 g/m² of fabric.

Preferred wetting agents are selected from ethoxylate, sulphonate and phosphonate nonionic wetting agents.

The crosslinked polymer on the fabric may further comprise an antimicrobial agent, preferably in an amount between 0.002-0.3 g/m² fabric, preferably between 0.005-0.1 g/m² fabric, more preferably between 0.01-0.05 g/m² fabric.

The antimicrobial agent may be selected from metal ions and metal salts, quaternary ammonium compounds, poly biguanid compounds, triclosan, n-halamine compounds, chitosan, peroxyacids.

In a process of production of a respiratory mask according to the invention, a woven fabric 10 having weft yarns 12 and warp yarns 11 as above discussed is provided. After weaving, the fabric undergoes singeing, desizing and bleaching, the two latter steps are preferably combined. Subsequently, a liquid-repellent aqueous composition is applied to (at least part of) the woven fabric 10. The woven fabric 10 is subsequently dried and the polymer liquid-repellent thin layer including a cross-linking agent is cured.

Preferably, the liquid-repellent aqueous composition is provided to the woven fabric 10 by padding. According to the padding process, the fabric is provided to a trough or vessel containing the aqueous liquid-repellent composition. The fabric is dipped into and impregnated with the aqueous liquid-repellent composition. Preferably, the aqueous liquid-repellent composition is provided to the fabric at a temperature between 20-35° C., preferably 23-28° C. The impregnated fabric is then passed between at least two rollers, i.e., squeezing rollers, so that the impregnated fabric is pressed and squeezed by the two rollers, so that the exceeding composition is removed. According to preferred embodiments, the squeezing rollers are set in order to obtain a wet pick-up between 75%-85%, preferably between 80%-83%. The so called “wet pick up” or “pick-up” is the amount of liquid absorbed by a fabric after it has been dipped and padded as a percentage of the weight of the dry fabric. Subsequently, the fabric may be dried and cured.

According to embodiments, the fabric provided with the composition, is dried at a temperature ranging from 100° C. to 150° C., preferably from 120° C. to 140° C.

According to embodiments, the fabric is cured at a temperature ranging from 150° C. to 220° C., preferably from 170° C. to 200° C., for a time preferably ranging from 30 s to 180 s, preferably from 40 s to 140 s.

According to embodiments, the dried fabric undergoes a sanforizing step. The sanforizing step may be performed according to techniques that are, per se, known in the art.

The fabric 10, dried and, preferably, cured, is then worked to provide the mask M, in particular the body 1 of the mask M. As discussed, one or more holding straps 3 may be separately produced and applied to the body 1 to obtain the mask M.

The aqueous liquid-repellent composition preferably comprises at least one or more liquid-repelling polymers, one or more crosslinking agents, optionally one or more wetting agents and, optionally, one or more antimicrobial agent.

Preferably, the liquid-repelling polymer in the aqueous composition is in an amount between, 20-300 g/l, preferably 90-200 g/l, more preferably 110-150 g/l.

Preferred liquid-repelling agents are selected from fluoropolymers. For example, preferred liquid-repelling agents may be selected from C6 based fluorocarbons, fluoro-silicone hybrids, C4 based fluoropolymers and mixtures thereof. For example, C6 fluoropolymers may be used as liquid-repelling agents.

Preferably, the crosslinking agent in the aqueous composition is in an amount between 2-50 g/l, preferably 5-40 g/l, more preferably 10-30 g/l. The crosslinking agent is preferably selected from the group consisting of acrylic polymers and copolymers, resins, polyurethanes, blocked isocyanates, poly-isocyanates, polycarboimides, polycarbodiimides and mixtures thereof.

The wetting agent in the aqueous liquid-repellent composition is preferably in an amount between 0.2-5 g/l, preferably 0.5-4 g/l, more preferably 1-3 g/l. Preferred wetting agents are selected from ethoxylate, sulphonate and phosphonate nonionic wetting agents, and mixtures thereof.

According to an aspect, the antimicrobial agent in the aqueous composition is in an amount between 1-30 g/l, preferably 5-20 g/l, more preferably 10-15 g/l. According to an aspect, the antimicrobial agent is selected from metal ions and metal salts, quaternary ammonium compounds, poly biguanid compounds, triclosan, n-halamine compounds, chitosan, peroxyacids.

It should be noted that the fabric 10 provided with the liquid-repellent crosslinked polymer may be used also for other articles, in particular medical garments comprising or consisting of the above discussed fabric 10, such as medical gown or similar garments.

In preferred embodiments, the woven fabric 10 is provided with warp yarns and weft yarns having a count between NE 20 and NE 40, wherein the warp yarns are preferably free from elastomeric fibers, while the weft yarns comprise elastomeric fibers (or filaments) in the core, covered by an inelastic sheath.

In these embodiments, warp density is comprised between 50 and 100 warps/cm, while weft density is comprised between 20 and 40 wefts/cm.

Preferred weaves for these fabrics are twill and sateen, in particular, 4/1 sateen.

These preferred fabrics typically have weight comprised between 110 and 300 g/m². Weft stretch of these preferred embodiments is typically between 30 and 60%, measured (as previously discussed) according to ASTM D3107, after 3 home washes.

In a preferred embodiment, the liquid-repellent crosslinked polymer on the mask comprises at least one liquid-repelling polymer in an amount between 0.5-10 g/m² of fabric, preferably between 1-9 g/m² of fabric, more preferably between 3-7 g/m² of fabric, at least one crosslinking agent in an amount between 0.1-5 g/m² of fabric, preferably between 0.5-3 g/m² of fabric, more preferably between 1-2 g/m² of fabric, at least one wetting agent in an amount between 0.001-0.2 g/m² of fabric, preferably between 0.005-0.1 g/m² of fabric, more preferably between 0.01-0.05 g/m² of fabric, and, optionally, at least one antimicrobial agent in an amount between 0.002-0.3 g/m² fabric, preferably between 0.005-0.1 g/m² fabric, more preferably between 0.01-0.05 g/m² fabric.

### EXAMPLES

Exemplary Fabric 1

An exemplary woven fabric suitable to be used in the present invention is as follows:
Warp Yarn count: Ne 36/1 100% cotton (8% being organic cotton)
Weft Yarn Count: Ne 30/1 94.47% cotton, 5.53% elastane
Fabric Weight (Washed): 225 g/m²
Warp density: 86.7 ends/cm
Weft density: 25.1 ends/cm
Fiber Composition: 98.32% cotton-1.68% elastane
Weave: 4/1 Sateen
Stretch (Weft): 45.6% measured according to ASTM D3107, after 3 home washes (as defined in ISO 6330:2012 6N, wherein 6N discloses the washing program). According to the present description, measurements according to ASTM D3107 are carried out using a weight of 3 lb, and the weight is applied to the fabric for 30 min.

Exemplary Fabric 2

An exemplary woven fabric suitable to be used in the present invention is as follows:
Warp Yarn count: Ne 36/1 100% cotton (6% being organic cotton)
Weft Yarn Count: Ne 30/1 94.47% cotton, 5.53% elastane
Fabric Weight (Washed): 218 g/m² after 3 home washes
Warp density: 86.3 ends/cm
Weft density: 25.1 ends/cm
Fiber Composition: 98% cotton-2% elastane
Weave: 4/1 Sateen
Stretch (Weft): 42% measured according to ASTM D3107, after 3 home washes (as defined in ISO 6330:2012 6N, wherein 6N discloses the washing program). According to the present description, measurements according to ASTM D3107 are carried out using a weight of 3 lb, and the weight is applied to the fabric for 30 min.

Exemplary Compositions

Exemplary compositions are as follows.

### Exemplary Composition 1

In water are admixed the following components:
Nuva N EE6 (fluorocarbon): 130 g/l
Arkophob Dan (crosslinking agent): 20 g/l
Fluowet UD (wetting agent): 2 g/l
pH adjusted to 4.5-5 with acetic acid.

### Exemplary Composition 2

In water are admixed the following components:
Nuva N EE6 (fluorocarbon): 130 g/l
Arkophob Dan (crosslinking agent): 20 g/l
Sanitized T 11-15 (antimicrobial agent): 12.5 g/l
Fluowet UD (wetting agent): 2 g/l
pH adjusted to 5.5-6 with acetic acid

Exemplary Process

An exemplary process for the production of a mask according to the invention comprises the following steps.
Singeing both sides of the fabric and combined oxidative desizing and bleaching;
Washing;
Drying;
providing the fabric with an aqueous liquid-repellent composition according to the present description by padding. For example, the “Exemplary composition 1” or the “Exemplary composition 2” may be used.
   Padding is carried out at a temperature between 20-35° C., preferably 23-28° C. (for example, between 26-28° C.). The fabric impregnated with the aqueous liquid-repellent composition is passed between two rollers, so the impregnated fabric is pressed and squeezed between the two rollers, whereby the that the exceeding composition is removed from the fabric. For example, the rollers (i.e., the squeezing rollers) are set to provide a 10 N/mm pressure to the fabric. Preferably, the squeezing rollers are set in order to obtain a wet pick-up between 80%-83%. As above mentioned, the so called “pick-up” or “wet pick up” is the amount of liquid absorbed by a fabric, after it has been dipped and padded, as a percentage of the weight of the dry fabric.
   Subsequently the fabric is dried at 130° C., and cured for 120 seconds at 190° C., using a stenter frame. Finally, the fabric is sanforized.
   When the “Exemplary composition 1” is used, the amount of the components in the fabric after drying and curing may be as follows:
   Nuva N EE6 (fluorocarbon): 4.8 g/m² of fabric
   Arkophob Dan (crosslinking agent): 1.6 g/m² of fabric
   Fluowet UD (wetting agent): 0.02 g/m² of fabric
   When the “Exemplary composition 2” is used, the amount of the components in the fabric after drying and curing may be as follows:
   Nuva N EE6 (fluorocarbon): 4.8 g/m² of fabric
   Arkophob Dan (crosslinking agent): 1.6 g/m² of fabric
   Sanitized T 11-15 (antimicrobial agent): 0.03 g/m² of fabric
   Fluowet UD (wetting agent): 0.02 g/m² of fabric
   The fabric so obtained is then worked to provide the mask according the invention, in particular the body of the mask. As discussed, one or more holding straps may be separately produced and applied to the body to obtain the mask.

Washing Tests

The “Exemplary fabric 1” above disclosed was treated with the “Exemplary composition 1”, according to the “exemplary process” above disclosed. The resulting fabric was washed 15 times at the conditions reported in the following table (Table 1):

TABLE 1
washing tests conditions

| | | | Weight of |
|---|---|---|---|
| process | Temperature | Duration | Detergent |
| 60° C. washing | 60° C. | 70-75 min | 25 gr |
| 90° C. washing | 90° C. | 80-85 min | 25 gr |

Before starting the tests (“control”), as well as after each washing, the following parameters were determined:
Air permeability—according to ASTM D 0737
Drop—according to AATCC 193
Spray—according to AATCC 22
   The results obtained are reported in the following table (Table 2):

TABLE 2

| | 60° C. washing | | | 90° C. washing | | |
|---|---|---|---|---|---|---|
| | Air | | | Air | | |
| | permeability | | | permeability | | |
| Number of | (ASTM D0737) | DROP | SPRAY | (ASTM D0737) | DROP | SPRAY |
| washing | mm/s | (AATCC 193) | (AATCC 22) | mm/s | (AATCC 193) | (AATCC 22) |
| Control | 103 | 8 | 100 | 103 | 8 | 100 |
| 1 | 130.35 | 8 | 100 | 131.6 | 8 | 80 |
| 2 | 139.4 | 8 | 80 | 140.25 | 8 | 80 |
| 3 | 134.7 | 8 | 80 | 136.75 | 8 | 80 |
| 4 | 140.5 | 8 | 80 | 138.3 | 8 | 70 |
| 5 | 139.85 | 8 | 70 | 133.8 | 8 | 70 |
| 6 | 138.9 | 8 | 70 | 139.95 | 8 | 70 |
| 7 | 144 | 8 | 70 | 140 | 8 | 70 |
| 8 | 145.2 | 8 | 70 | 140.1 | 8 | 70 |
| 9 | 144.6 | 8 | 70 | 138.8 | 8 | 70 |
| 10 | 145.8 | 8 | 70 | 145 | 8 | 70 |
| 11 | 147.2 | 8 | 70 | 142.9 | 8 | 70 |
| 12 | 148.9 | 8 | 70 | 144.1 | 8 | 70 |
| 13 | 149.9 | 8 | 70 | 145 | 8 | 70 |
| 14 | 147.6 | 8 | 70 | 144.8 | 8 | 50 |
| 15 | 150 | 8 | 70 | 144 | 8 | 50 |

The above values show how, after the first washing, a mask according to the present invention has only minimum increase in air permeability after the subsequent washing cycles. For example, considering the above discussed example, the value of air permeability after the 15th washing is only 15% greater than the value of air permeability after the first washing, considering the washing cycles at 60° C. degrees. Similarly, the increase is only 9.5% considering the washing cycles carried out at 90° C. degrees.

1. A respiratory mask (M) including a mask fabric body (1), having a first face and a second face, and one or more holding straps (3) for holding the mask body to the face of a user, the mask body being made of a woven fabric having weft yarns (12) and warp yarns (11), the weft and warp yarns (12, 11) having a count comprised between 10 and 1100 den, the warp density being between 14-130 warps/cm, the weft density being between 12-70 wefts/cm, wherein at least part of the body is provided with a liquid-repellent crosslinked polymer.

2. The mask (M) according to claim 1, wherein said liquid-repellent crosslinked polymer is provided at least on said first face and body through at least part of the thickness of said body (1).

3. The mask (M) according to claim 1, wherein the warp and/or weft yarns comprise yarns comprising staple fibers, having a count comprised between NE 5 and NE 80.

4. The mask (M) according to claim 3, wherein said yarns comprising staple fibers comprise a core comprising elastomeric fibers, and a sheath of staple fibers, the count of said elastomeric core being between 5 and 900 den.

5. The mask (M) according to claim 1, wherein the warp and/or weft yarns comprise yarns consisting of man-made fibers, having a count comprised between 10 and 1000 den.

6. The mask (M) according to claim 5, wherein said man-made fibers comprise one or more elastomeric filament, the total count of elastomeric filaments being between 5 and 900 den.

7. The mask (M) according to claim 1, wherein said body is made from a woven fabric having a weight comprised between 60 and 500 g/m2, said weight being referred to said fabric provided with said liquid-repellent crosslinked polymer.

8. The mask (M) according to claim 1, wherein:
the count of the warp and of the weft yarns is comprised between 20 and 600 den, and/or
the warp density is comprised between 50 and 100 warps/cm, and/or
the weft density is comprised between 20 and 40 wefts/cm.

9. The mask (M) according to claim 1, wherein said body is made from a woven fabric having air permeability according to ASTM D0737 between 30 and 800 mm/s, said air permeability being referred to said fabric provided with said liquid-repellent crosslinked polymer.

10. The mask (M) according to claim 1, wherein said body is made from a woven fabric having elongation, after 3 home washes, in warp and/or weft direction comprised between 10 and 60% according to ASTM D3107.

11. The mask according to claim 1, wherein said liquid-repellent crosslinked polymer comprises at least one or more liquid-repelling polymers, one or more crosslinking agents, and optionally one or more wetting agents.

12. The mask according to claim 11, wherein said liquid-repelling polymer is in an amount between 0.5-10 g/m2 of fabric.

13. The mask according to claim 11, wherein said liquid-repelling polymer is a fluoropolymer, selected from C6 based fluorocarbons, fluoro-silicone hybrids, C4 based fluoropolymers, and mixtures thereof.

14. The mask according to claim 11, wherein said crosslinking agent is in an amount between 0.1-5 g/m2 of fabric, said crosslinking agent being selected from acrylic polymers and copolymers, resins, polyurethanes, blocked isocyanates, poly-isocyanates, polycarboimides, polycarbodiimides and mixtures thereof.

15. The mask according to claim 11, wherein said wetting agent is in an amount between 0.001-0.2 g/m2 of fabric, said wetting agent being selected from ethoxylate, sulphonate and phosphonate nonionic wetting agents.

16. The mask according to claim 11, wherein said crosslinked polymer further comprises an antimicrobial agent, in an amount between 0.002-0.3 g/m2 fabric, said antimicrobial agent being selected from metal ions and metal salts, quaternary ammonium compounds, poly biguanid compounds, triclosan, n-halamine compounds, chitosan, and peroxyacids.

17. The mask according to claim 1, wherein the weave of the fabric (10) is selected from Sateen, Plain, Twill, Double Face, Panama, Ribs, and Mixed Dobby Weave.

18. A process for the production of a respiratory mask according to claim 1, comprising the following steps:
a. providing a woven fabric having weft yarns and warp yarns, the weft and warp yarns having a count comprised between 10 and 1100 den, the warp density being between 14-130 warps/cm, the weft density being between 12-70 wefts/cm;
b. providing at least part of said woven fabric with an aqueous liquid-repellent composition, impregnating said woven fabric with an aqueous liquid-repellent composition, drying, and, curing, to obtain a treated fabric;
c. sanforizing the treated fabric of point b.,
d. working said fabric of point c. into a mask.

19. The process according to claim 18, wherein said aqueous liquid-repellent composition comprises at least one liquid-repellent agent that is a polymer, one or more crosslinking agents in an amount between 2-50 g/l, one or more wetting agents and, optionally, one or more antimicrobial agent.

20. The process according to claim 19, wherein said liquid-repellent agent is in an amount between 20-300 g/l.

21. The process according to claim 19, wherein said liquid-repelling agent is selected from C6 based fluorocarbons, fluoro-silicone hybrids, C4 based fluoropolymers, and mixtures thereof; said crosslinking agent is selected from the group consisting of acrylic polymers and copolymers, resins, polyurethanes, blocked isocyanates, poly-isocyanates, polycarboimides, polycarbodiimides and mixtures thereof.

22. The process according to claim 19, wherein said wetting agent is said aqueous liquid-repellent composition is in an amount between 0.2-5 g/l, said wetting agent being selected from ethoxylate, sulphonate and phosphonate nonionic wetting agents, and mixtures thereof.
